(19) United States
(12) Patent Application Publication
(10) Pub. No.: US 2015/0269425 A1
(43) Pub. Date: Sep. 24, 2015

(54) DYNAMIC HAND GESTURE RECOGNITION WITH SELECTIVE ENABLING BASED ON DETECTED HAND VELOCITY

(71) Applicant: LSI Corporation, Sam Jose, CA (US)

(72) Inventors: Ivan L. Mazurenko, Moscow (RU); Barrett Brickner, Mendota Heights, MN (US); Alexander A. Petyushko, Moscow (RU); Denis V. Parkhomenko, Moscow (RU); Alexander B. Kholodenko, Moscow (RU)

(21) Appl. No.: 14/357,894

(22) PCT Filed: Apr. 18, 2014
(86) PCT No.: PCT/US14/34586

§ 371 Date: May 13, 2014

(30) Foreign Application Priority Data
Oct. 17, 2013 (RU) 2013146529

(51) Int. Cl. G06K 9/00; G06T 7/00; G06K 9/62; G06T 7/20

(52) U.S. Cl. CPC G06K 9/00335; G06T 7/204; G06T 7/0044; G06K 9/6215; G06K 9/6256; G06T 2207/30196; G06T 2207/30241

(57) ABSTRACT

An image processing system comprises an image processor configured to determine velocity of a hand in a plurality of images, and to selectively enable dynamic gesture recognition for at least one image responsive to the determined velocity. By way of example, the image processor illustratively includes a dynamic gesture preprocessing detector and a dynamic gesture recognizer, with the dynamic gesture preprocessing detector being configured to determine the velocity of the hand for a current frame and to compare the determined velocity to a specified velocity threshold. If the determined velocity is greater than or equal to the velocity threshold, the dynamic gesture recognizer operates on the current frame, and otherwise the dynamic gesture recognizer is bypassed for the current frame. The dynamic gesture recognizer when enabled is configured to generate similarity measures for respective ones of a plurality of gestures of a gesture vocabulary for the current frame.

### FIELD

The field relates generally to image processing, and more particularly to image processing for recognition of gestures.

### BACKGROUND

Image processing is important in a wide variety of different applications, and such processing may involve two-dimensional (2D) images, three-dimensional (3D) images, or combinations of multiple images of different types. For example, a 3D image of a spatial scene may be generated in an image processor using triangulation based on multiple 2D images captured by respective cameras arranged such that each camera has a different view of the scene. Alternatively, a 3D image can be generated directly using a depth imager such as a structured light (SL) camera or a time of flight (ToF) camera. These and other 3D images, which are also referred to herein as depth images, are commonly utilized in machine vision applications, including those involving gesture recognition.

In a typical gesture recognition arrangement, raw image data from an image sensor is usually subject to various preprocessing operations. The preprocessed image data is then subject to additional processing used to recognize gestures in the context of particular gesture recognition applications. Such applications may be implemented, for example, in video gaming systems, kiosks or other systems providing a gesture-based user interface. These other systems include various electronic consumer devices such as laptop computers, tablet computers, desktop computers, mobile phones and television sets.

### SUMMARY

In one embodiment, an image processing system comprises an image processor configured to determine velocity of a hand in a plurality of images, and to selectively enable dynamic gesture recognition for at least one image responsive to the determined velocity. By way of example, the image processor illustratively includes a dynamic gesture preprocessing detector and a dynamic gesture recognizer, with the dynamic gesture preprocessing detector being configured to determine the velocity of the hand for a current frame and to compare the determined velocity to a specified velocity threshold. If the determined velocity is greater than or equal to the velocity threshold, the dynamic gesture recognizer operates on the current frame, and otherwise the dynamic gesture recognizer is bypassed for the current frame. The dynamic gesture recognizer when enabled is configured to generate similarity measures for respective ones of a plurality of gestures of a gesture vocabulary for the current frame.

Other embodiments of the invention include but are not limited to methods, apparatus, systems, processing devices, integrated circuits, and computer-readable storage media having computer program code embodied therein.

### BRIEF DESCRIPTION OF THE DRAWINGS

FIG. 1 is a block diagram of an image processing system comprising an image processor with a dynamic gesture subsystem implementing a process for recognition of dynamic hand gestures in an illustrative embodiment.

FIG. 2 shows a more detailed view of the dynamic gesture subsystem of the image processor of the FIG. 1 system, illustrating exemplary interaction between a dynamic gesture preprocessing detector, a dynamic gesture recognizer and other components of the dynamic gesture subsystem.

FIG. 3 shows a more detailed view of the dynamic gesture recognizer of FIG. 2 in an illustrative embodiment.

### DETAILED DESCRIPTION

Embodiments of the invention will be illustrated herein in conjunction with exemplary image processing systems that include image processors or other types of processing devices implementing techniques for improved dynamic gesture recognition. It should be understood, however, that embodiments of the invention are more generally applicable to any image processing system or associated device or technique that involves recognizing dynamic gestures in one or more images.

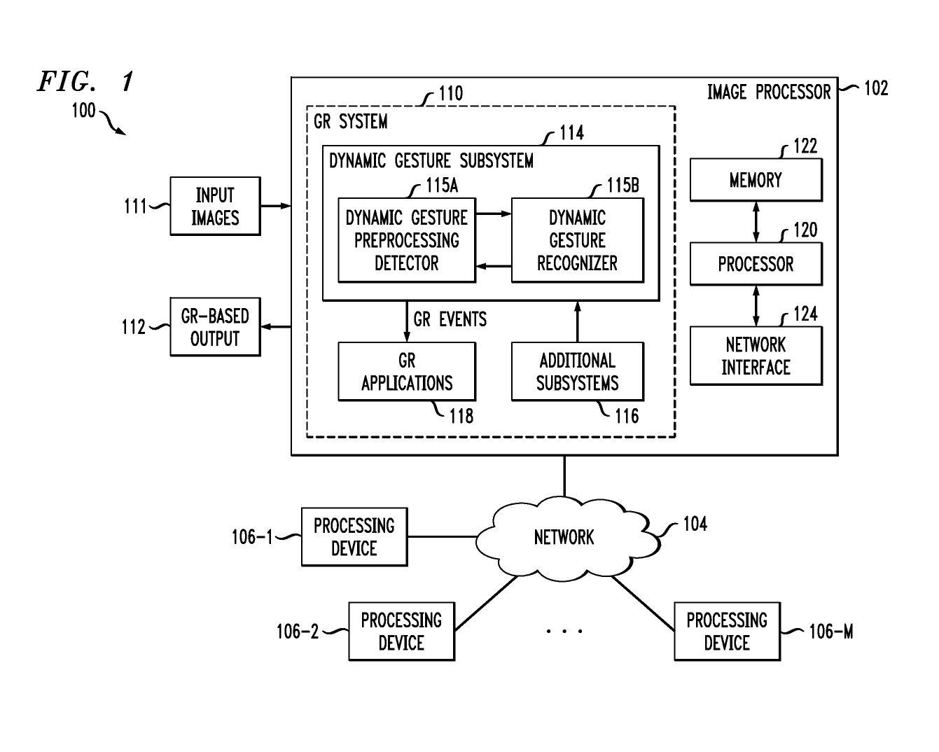

FIG. 1 shows an image processing system 100 in an embodiment of the invention. The image processing system 100 comprises an image processor 102 that is configured for communication over a network 104 with a plurality of processing devices 106-1, 106-2, . . . 106-M. The image processor 102 implements a gesture recognition (GR) system 110. The GR system 110 in this embodiment processes input images 111 from one or more image sources and provides corresponding GR-based output 112. The GR-based output 112 may be supplied to one or more of the processing devices 106 or to other system components not specifically illustrated in this diagram.

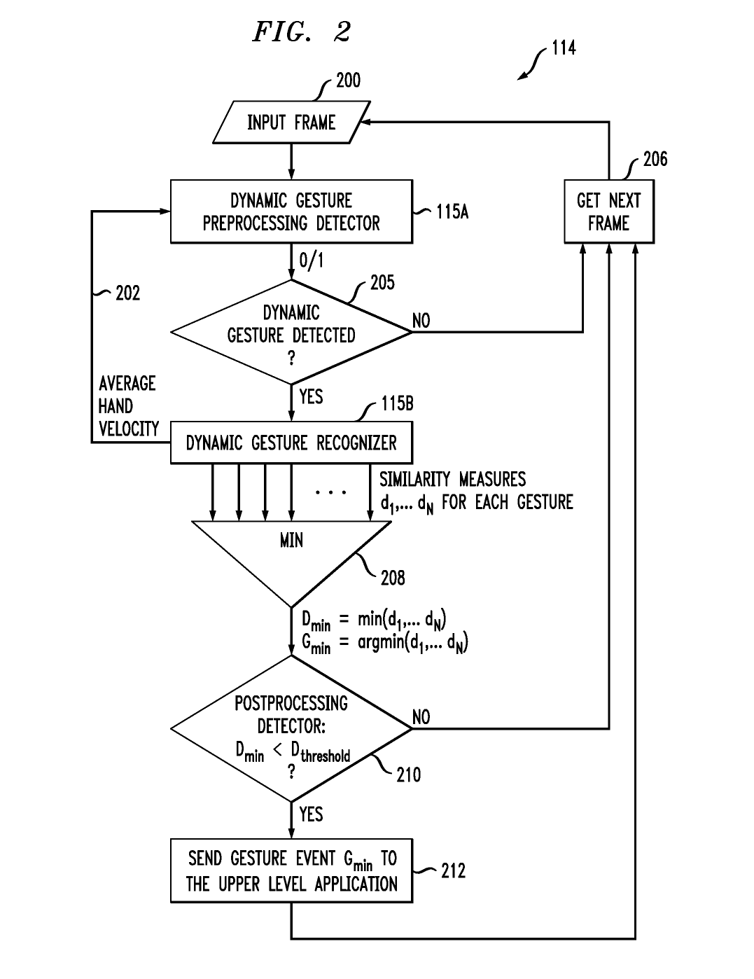

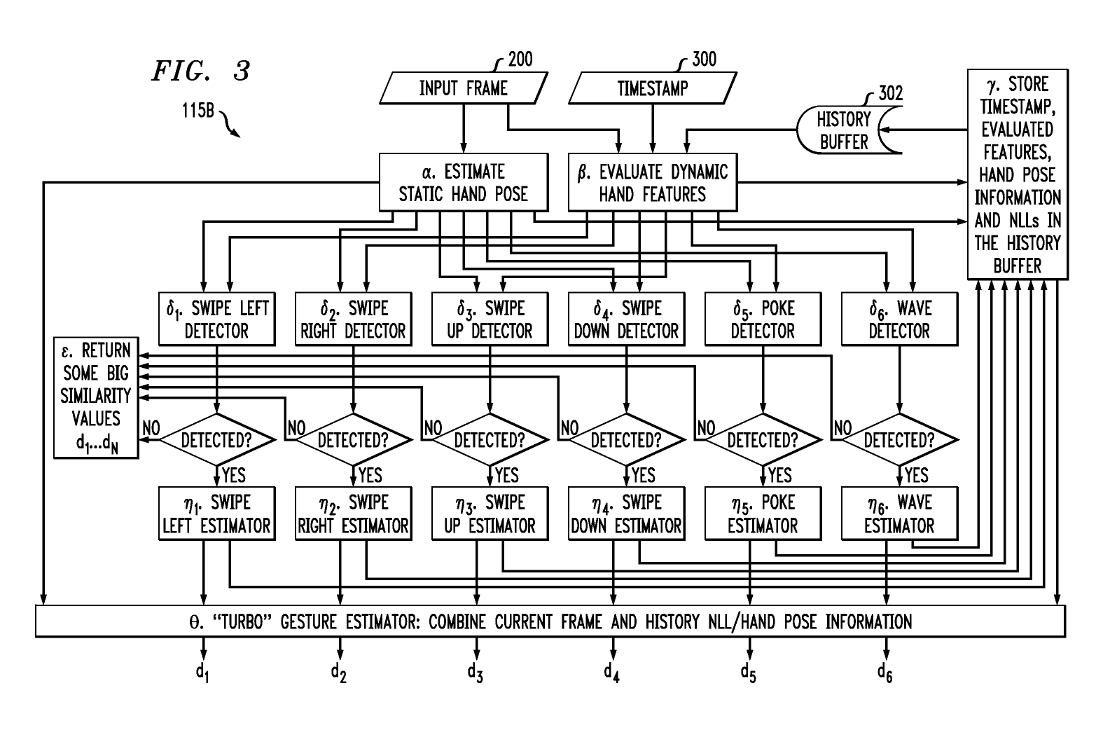

The GR system 110 more particularly comprises a dynamic gesture subsystem 114 that includes a dynamic gesture preprocessing detector 115A coupled to a dynamic gesture recognizer 115B. The GR system in the present embodiment is configured to implement a gesture recognition process in which a dynamic gesture recognition portion of the process performed in dynamic gesture recognizer 115B is selectively enabled using hand velocity determined by the preprocessing detector 115A. The operation of the dynamic gesture subsystem 114 will be described in greater detail below in conjunction with FIGS. 2 and 3.

The dynamic gesture subsystem 114 receives inputs from additional subsystems 116, which may comprise one or more image processing subsystems configured to implement functional blocks associated with gesture recognition in the GR system 110, such as, for example, functional blocks for input frame acquisition, preprocessing, noise and background estimation and removal, hand detection and tracking, and static hand pose recognition. It should be understood, however, that these particular functional blocks are exemplary only, and other embodiments of the invention can be configured using other arrangements of additional or alternative functional blocks.

In the FIG. 1 embodiment, the dynamic gesture subsystem 114 generates GR events for consumption by one or more GR applications 118. For example, the GR events may comprise information indicative of recognition of one or more particular gestures within one or more frames of the input images 111, such that a given GR application can translate that information into a particular command or set of commands to be executed by that application.

Additionally or alternatively, the GR system 102 may provide GR events or other information, possibly generated by one or more of the GR applications 118, as GR-based output 112. Such output may be provided to one or more of the processing devices 106. In other embodiments, at least a portion of the GR applications 118 is implemented at least in part on one or more of the processing devices 106.

Portions of the GR system 110 may be implemented using separate processing layers of the image processor 102. These processing layers comprise at least a portion of what is more generally referred to herein as “image processing circuitry” of the image processor 102. For example, the image processor 102 may comprise a preprocessing layer implementing a preprocessing module and a plurality of higher processing layers for performing other functions associated with recognition of hand gestures within frames of an input image stream comprising the input images 111. Such processing layers may also be implemented in the form of respective subsystems of the GR system 110.

It should be noted, however, that embodiments of the invention are not limited to recognition of dynamic hand gestures, but can instead be adapted for use in a wide variety of other machine vision applications involving gesture recognition, and may comprise different numbers, types and arrangements of modules, subsystems, processing layers and associated functional blocks.

Also, certain processing operations associated with the image processor 102 in the present embodiment may instead be implemented at least in part on other devices in other embodiments. For example, preprocessing operations may be implemented at least in part in an image source comprising a depth imager or other type of imager that provides at least a portion of the input images 111. It is also possible that one or more of the applications 118 may be implemented on a different processing device than the subsystems 114 and 116, such as one of the processing devices 106.

Moreover, it is to be appreciated that the image processor 102 may itself comprise multiple distinct processing devices, such that different portions of the GR system 110 are implemented using two or more processing devices. The term “image processor” as used herein is intended to be broadly construed so as to encompass these and other arrangements.

The GR system 110 performs preprocessing operations on received input images 111 from one or more image sources. This received image data in the present embodiment is assumed to comprise raw image data received from a depth sensor, but other types of received image data may be processed in other embodiments. Such preprocessing operations may include noise reduction and background removal.

The raw image data received by the GR system 110 from the depth sensor may include a stream of frames comprising respective depth images, with each such depth image comprising a plurality of depth image pixels. For example, a given depth image D may be provided to the GR system 110 in the form of matrix of real values. A given such depth image is also referred to herein as a depth map.

A wide variety of other types of images or combinations of multiple images may be used in other embodiments. It should therefore be understood that the term “image” as used herein is intended to be broadly construed.

The image processor 102 may interface with a variety of different image sources and image destinations. For example, the image processor 102 may receive input images 111 from one or more image sources and provide processed images as part of GR-based output 112 to one or more image destinations. At least a subset of such image sources and image destinations may be implemented as least in part utilizing one or more of the processing devices 106.

Accordingly, at least a subset of the input images 111 may be provided to the image processor 102 over network 104 for processing from one or more of the processing devices 106. Similarly, processed images or other related GR-based output 112 may be delivered by the image processor 102 over network 104 to one or more of the processing devices 106. Such processing devices may therefore be viewed as examples of image sources or image destinations as those terms are used herein.

A given image source may comprise, for example, a 3D imager such as an SL camera or a ToF camera configured to generate depth images, or a 2D imager configured to generate grayscale images, color images, infrared images or other types of 2D images. It is also possible that a single imager or other image source can provide both a depth image and a corresponding 2D image such as a grayscale image, a color image or an infrared image. For example, certain types of existing 3D cameras are able to produce a depth map of a given scene as well as a 2D image of the same scene. Alternatively, a 3D imager providing a depth map of a given scene can be arranged in proximity to a separate high-resolution video camera or other 2D imager providing a 2D image of substantially the same scene.

Another example of an image source is a storage device or server that provides images to the image processor 102 for processing.

A given image destination may comprise, for example, one or more display screens of a human-machine interface of a computer or mobile phone, or at least one storage device or server that receives processed images from the image processor 102.

It should also be noted that the image processor 102 may be at least partially combined with at least a subset of the one or more image sources and the one or more image destinations on a common processing device. Thus, for example, a given image source and the image processor 102 may be collectively implemented on the same processing device. Similarly, a given image destination and the image processor 102 may be collectively implemented on the same processing device.

In the present embodiment, the image processor 102 is configured to recognize dynamic hand gestures, although the disclosed techniques can be adapted in a straightforward manner for use with other types of gesture recognition processes.

As noted above, the input images 111 may comprise respective depth images generated by a depth imager such as an SL camera or a ToF camera. Other types and arrangements of images may be received, processed and generated in other embodiments, including 2D images or combinations of 2D and 3D images.

The particular arrangement of subsystems, applications and other components shown in image processor 102 in the FIG. 1 embodiment can be varied in other embodiments. For example, an otherwise conventional image processing integrated circuit or other type of image processing circuitry suitably modified to perform processing operations as disclosed herein may be used to implement at least a portion of one or more of the components 114, 116 and 118 of image processor 102. One possible example of image processing circuitry that may be used in one or more embodiments of the invention is an otherwise conventional graphics processor suitably reconfigured to perform functionality associated with one or more of the components 114, 116 and 118.

The processing devices 106 may comprise, for example, computers, mobile phones, servers or storage devices, in any combination. One or more such devices also may include, for example, display screens or other user interfaces that are utilized to present images generated by the image processor 102. The processing devices 106 may therefore comprise a wide variety of different destination devices that receive processed image streams or other types of GR-based output 112 from the image processor 102 over the network 104, including by way of example at least one server or storage device that receives one or more processed image streams from the image processor 102.

Although shown as being separate from the processing devices 106 in the present embodiment, the image processor 102 may be at least partially combined with one or more of the processing devices 106. Thus, for example, the image processor 102 may be implemented at least in part using a given one of the processing devices 106. As a more particular example, a computer or mobile phone may be configured to incorporate the image processor 102 and possibly a given image source. Image sources utilized to provide input images 111 in the image processing system 100 may therefore comprise cameras or other imagers associated with a computer, mobile phone or other processing device. As indicated previously, the image processor 102 may be at least partially combined with one or more image sources or image destinations on a common processing device.

The image processor 102 in the present embodiment is assumed to be implemented using at least one processing device and comprises a processor 120 coupled to a memory 122. The processor 120 executes software code stored in the memory 122 in order to control the performance of image processing operations. The image processor 102 also comprises a network interface 124 that supports communication over network 104. The network interface 124 may comprise one or more conventional transceivers. In other embodiments, the image processor 102 need not be configured for communication with other devices over a network, and in such embodiments the network interface 124 may be eliminated.

The processor 120 may comprise, for example, a microprocessor, an application-specific integrated circuit (ASIC), a field-programmable gate array (FPGA), a central processing unit (CPU), an arithmetic logic unit (ALU), a digital signal processor (DSP), or other similar processing device component, as well as other types and arrangements of image processing circuitry, in any combination.

The memory 122 stores software code for execution by the processor 120 in implementing portions of the functionality of image processor 102, such as the subsystems 114 and 116 and the GR applications 118. A given such memory that stores software code for execution by a corresponding processor is an example of what is more generally referred to herein as a computer-readable medium or other type of computer program product having computer program code embodied therein, and may comprise, for example, electronic memory such as random access memory (RAM) or read-only memory (ROM), magnetic memory, optical memory, or other types of storage devices in any combination. As indicated above, the processor may comprise portions or combinations of a microprocessor, ASIC, FPGA, CPU, ALU, DSP or other image processing circuitry.

It should also be appreciated that embodiments of the invention may be implemented in the form of integrated circuits. In a given such integrated circuit implementation, identical die are typically formed in a repeated pattern on a surface of a semiconductor wafer. Each die includes an image processor or other image processing circuitry as described herein, and may include other structures or circuits. The individual die are cut or diced from the wafer, then packaged as an integrated circuit. One skilled in the art would know how to dice wafers and package die to produce integrated circuits. Integrated circuits so manufactured are considered embodiments of the invention.

The particular configuration of image processing system 100 as shown in FIG. 1 is exemplary only, and the system 100 in other embodiments may include other elements in addition to or in place of those specifically shown, including one or more elements of a type commonly found in a conventional implementation of such a system.

For example, in some embodiments, the image processing system 100 is implemented as a video gaming system or other type of gesture-based system that processes image streams in order to recognize user gestures. The disclosed techniques can be similarly adapted for use in a wide variety of other systems requiring a gesture-based human-machine interface, and can also be applied to other applications, such as machine vision systems in robotics and other industrial applications that utilize gesture recognition.

Also, as indicated above, embodiments of the invention are not limited to use in recognition of hand gestures, but can be applied to other types of gestures as well. The term “gesture” as used herein is therefore intended to be broadly construed.

The operation of the image processor 102 will now be described in greater detail with reference to the diagram of FIG. 2. The diagram illustrates an exemplary implementation of the dynamic gesture subsystem 114 of the GR system 110, including the dynamic gesture preprocessing detector 115A and the dynamic gesture recognizer 115B as well as other supporting components.

It is further assumed in this embodiment that the input images 111 received in the image processor 102 from an image source comprise input depth images each referred to as an input frame. As indicated above, this source may comprise a depth imager such as an SL or ToF camera comprising a depth image sensor. Other types of image sensors including, for example, grayscale image sensors, color image sensors or infrared image sensors, may be used in other embodiments. A given image sensor typically provides image data in the form of one or more rectangular matrices of real or integer numbers corresponding to respective input image pixels. These matrices can contain per-pixel information such as depth values and corresponding amplitude or intensity values. Other per-pixel information such as color, phase and validity may additionally or alternatively be provided.

As illustrated in FIG. 2, a current input frame 200 is applied to the dynamic gesture preprocessing detector 115A. This detector is configured to detect movement of a hand in one or more input frames, so that a determination can be made regarding whether or not the detected movement is likely to correspond to one of a plurality of predetermined dynamic hand gestures supported by the GR system 110. The supported gestures are more denoted herein by the set G={G₁, G₂, . . . , G_{N}} where N denotes the total number of supported gestures. The set G is also referred to herein as the gesture vocabulary of the GR system 110.

In the present embodiment, the supported gestures are assumed by way of example to include a swipe left gesture, a swipe right gesture, a swipe up gesture, a swipe down gesture, a poke gesture and a wave gesture, such that G={swipe left, swipe right, swipe down, swipe up, poke, wave}, although various subsets of these gestures as well as additional or alternative gestures may be supported in other embodiments. Accordingly, embodiments of the invention are not limited to use with any particular gesture vocabulary.

The dynamic gesture preprocessing detector 115A estimates an absolute value or magnitude of an average hand velocity V using the input frame 200 and at least one previous frame. This determination in the present embodiment also illustratively incorporates average hand velocity information for one or more previous frames as supplied to the dynamic gesture preprocessing detector 115A by the dynamic gesture recognizer 115B via line 202. The term “average” in this context should be understood to encompass, for example, averaging of multiple velocity measures determined for respective pixels associated with a hand region of interest (ROI), although other types of averaging could be used. A given velocity measure may be determined, for example, based on movement of a particular point in the ROI between current and previous frames.

The dynamic gesture preprocessing detector 115A compares the average hand velocity V with a predefined velocity threshold Vₘᵢₙ. If the average hand velocity V is greater than or equal to the velocity threshold Vₘᵢₙ, the detector 115A returns a logic 1, and otherwise returns a logic 0. The velocity threshold Vₘᵢₙ will vary depending upon the type of gestures supported by the GR system, but exemplary Vₘᵢₙ values for the set G of dynamic hand gestures mentioned above are on the order of about 0.5 to 1.0 meters per second.

By way of example, the average hand velocity may comprise hand velocity coordinates Vx, Vy and Vz and the magnitude of the velocity may be determined as V=sqrt(Vx̂2+Vŷ2+Vẑ2), although other velocity measures may be used in other embodiments.

A decision block 205 utilizes the binary output of the dynamic gesture preprocessing detector 115A to determine if a dynamic gesture is detected in the input frame 200. For a value of 0 from the detector 115A, the decision block indicates that no dynamic gesture is detected and the process moves to block 206 to get the next frame. For a value of 1 from the detector 115A, the decision block indicates that a dynamic gesture is detected, and the process moves to the dynamic gesture recognizer 115B. The dynamic gesture recognizer 115B is also assumed to receive the input frame 200, although this connection is not explicitly shown in the simplified diagram of FIG. 2. The decision block 205 in other embodiments may be incorporated into the detector 115A, rather than implemented outside of detector 115A as in the FIG. 2 embodiment.

The dynamic gesture recognizer 115B generates similarity measures d₁, d₂, . . . d_{N} for respective ones of the gestures G₁, G₂, . . . , G_{N}. By way of example, the similarity measures may be based on respective probabilities or probability densities {Pᵢ, i=1 . . . N} each indicating the likelihood of the detected hand movement corresponding to a particular gesture in G. As a more particular example, similarity measures may be defined as dᵢ=−log(Pi), in which case the similarity measures comprise respective negative log likelihoods (NLLs) of a statistical classifier. Although some embodiments disclosed herein utilize NLLs, other types of similarity measures may be used in other embodiments. Also, the embodiments that utilize NLLs can be reconfigured in a straightforward manner to utilize other types of similarity measures.

The similarity measures generated by the dynamic gesture recognizer 115B are applied to a minimum determining element 208 which determines Dₘᵢₙ=min(d₁, d₂, . . . d_{N}) as the minimum of the similarity measures d₁, d₂, . . . d_{N}, and identifies Gₘᵢₙ=argmin(d₁, d₂, . . . d_{N}) as the particular gesture for which the minimum similarity measure Dₘᵢₙ was achieved. The minimum determining element 208 is an example of what is more generally referred to herein as a “selection element,” and in other embodiments other types of selection elements may be used. For example, use of certain types of similarity measures may necessitate use of a maximization function rather than a minimization function in the selection element.

A postprocessing detector is implemented in decision block 210 to determine if Dₘᵢₙ is below a specified gesture recognition threshold D_{threshold}. If Dₘᵢₙ is not below the threshold, a dynamic gesture is not recognized in the current frame and the process moves to block 206 to obtain the next frame. If Dₘᵢₙ is below the threshold, a GR event is generated indicating that gesture Gₘᵢₙ has been recognized in the current frame, and the GR event is sent to an upper level application, illustratively one of the GR applications 118, as indicated in block 212. The postprocessing detector in decision block 210 is generally configured to reject out-of-vocabulary hand movements. In some embodiments, the threshold D_{threshold} is set to infinity or to an arbitrary large value so that no dynamic gestures recognized by the dynamic gesture recognizer 115B are rejected. The threshold D_{threshold} is an example of what is more generally referred to herein as a distance threshold.

After generation of the GR event in block 212, the process returns to step 206 to get the next frame. The above-described processing is then repeated with the next frame serving as the current input frame.

Referring now to FIG. 3, a more detailed view of the dynamic gesture recognizer 115B is shown. As indicated above, the recognizer 115B processes input frame 200. In this embodiment, the recognizer 115B also utilizes timestamp 300 and history buffer 302. The recognizer includes a plurality of processing blocks denoted as Block α, Block β, Block γ, Blocks δ₁ through δ₆, Block ε, Blocks η₁ through η₆, and Block θ, all of which will be described in more detail below. This embodiment uses the above-noted exemplary gesture vocabulary G={swipe left, swipe right, swipe down, swipe up, poke, wave}, and thus N=6 and the recognizer 115B generates six output similarity measures d₁, d₂, . . . d₆ for respective ones of the six supported gestures. Again, other gesture vocabularies can be used in other embodiments, and the configuration of the dynamic gesture recognizer 115B adjusted accordingly.

Block α of the dynamic gesture recognizer 115B estimates static hand pose for the current input frame 200. An exemplary implementation of this block is as follows:

1. Analyze the gesture vocabulary G in terms of typical static hand poses while a user performs each gesture and split G into non-intersecting non-empty subsets of gestures G=G¹ U G² U . . . U G^{K} where K<=N and each set Gⁱ unites different dynamic gestures where typical hand shape is the same or non-distinguishable. For example, if G={swipe left, swipe right, swipe down, swipe up, poke, wave}, the following subsets can be used: G¹={swipe left, swipe right}, G²={swipe down, swipe up, wave}, G³={poke}. In this example, the number of gesture classes K is equal to 3.

2. Collect sample recordings for each gesture from G for different users, recording conditions and other use cases.

3. Train K classifiers to recognize the hand poses from respective ones of the gesture classes G¹, G², . . . , G^{K}. The i-th classifier should be trained using sample recordings for all gestures from class Gⁱ. For example, to train the classifier for class G²={swipe down, swipe up, wave}, recordings for all three gestures in the class should be combined in one training set. Any of a variety of different classification techniques, including Nearest Neighbor, Gaussian Mixture Models (GMMs), Decision Trees, and Neural Networks may be used for these classifiers. Other static hand pose recognition processes may also be used.

Block α is illustratively configured to return similarity measures s₁,s₂, . . . s_{K} from respective ones of the K classifiers. By way of example, the similarity measures sᵢ may correspond to NLLs if GMMs are used to classify the hand shapes. The similarity values s₁,s₂, . . . s_{K} are used by detector Blocks δ₁ through δ₆ and estimator Blocks η₁ through η₆ and are also saved in the history buffer 302 for further processing in Block γ.

Block β of the dynamic gesture recognizer 115B evaluates dynamic hand features in the current input frame 200. Such features are examples of what are more generally referred to herein as dynamic hand parameters, and in the present embodiment include, for example, hand velocity coordinates Vx, Vy and Vz; hand position coordinates X, Y and Z; distance coordinates dx, dy and dz characterizing distance travelled by the hand during a certain fixed period of time corresponding to average duration of a dynamic gesture (e.g., 0.5 seconds), which may take on negative or positive values; maximal and minimal hand velocity coordinates Vxₘᵢₙ, Vxₘₐₓ, Vyₘᵢₙ, Vyₘₐₓ, Vzₘᵢₙ and Vzₘₐₓ; acceleration coordinates Ax, Ay and Az; magnitude of velocity V=sqrt(Vx̂2+Vŷ2+Vẑ2), and possibly additional or alternative parameters.

Estimation of these dynamic features utilizes the history buffer 302 where data from previous frames is stored. The history buffer 302 may be implemented as a circular array of a fixed size so that writing new data to the buffer automatically erases a buffer tail corresponding to the oldest data in the buffer.

A number of examples of estimation of dynamic features, in some cases using the previous frame data stored in the history buffer 302, will now be described.

As a first example, velocity coordinate Vx can be estimated using the following formula:

Vx=(x(n)−x(n−1))/(t(n)−t(n−1)),

where n is an index of the current frame and t(n) is the timestamp in seconds of frame n. Velocity coordinates Vy and Vz may be determined in a similar manner.

Examples of techniques for estimating the hand position coordinates X, Y and Z include the following:

1. Estimate average X, Y and Z coordinates of pixels corresponding to a hand ROI. This may more particularly involve estimation of center of mass coordinates.

2. Estimate average X, Y and Z coordinates of pixels corresponding to a finger tip of the hand where the fingertip is defined as the point of the hand most distant from the user.

3. Estimate 3D coordinates of intersection of a ray that interpolates a pointing finger, hand or arm, in a least mean square or principal components sense, and a plane corresponding to a virtual or real screen of a user interface.

4. Estimate using at least a subset of the following steps, particularly well-suited for use with a ToF image sensor in which depth error is on average inversely monotonically proportional to pixel amplitude:
(a) Remove invalid pixels from the ROI, where pixel validity may be returned on a per-frame basis from the sensor or estimated using different techniques. For example, pixel validity may be determined by analyzing average depth deviation as described in Russian Patent Application No. 2013135506, filed Jul. 29, 2013 and entitled “Image Processor Configured for Efficient Estimation and Elimination of Background Information in Images,” which is commonly assigned herewith and incorporated by reference herein.
(b) Estimate average amplitude A_{avg} of pixels inside the ROI and amplitude deviation A_{std} and remove pixels from the ROI having amplitude less than A_{avg}−m*A_{std} where m is a positive constant, for example, m=3.
(c) Take L most distant pixels of the ROI and estimate average X, Y and Z coordinates of these pixels. Here L is a constant which depends on average hand image size and sensor resolution. For a typical ToF sensor, L may be taken equal to 100 pixels. The idea here is to reduce the amount of noise by means of averaging and to make the noise reduction factor invariant to the number of pixels in the ROI.

A given one of the above-described exemplary techniques for estimating hand position coordinates may be selected based on the type of image sensor used. For example, the third technique above in some embodiments produces relatively high precision results for a typical ToF image sensor having low depth resolution.

After estimating velocity and position coordinates as well as other dynamic features, temporal filtering or other smoothing techniques may be applied using the history buffer 302 in order to reduce the level of jitter in estimated hand dynamic features. For example, simple exponential averaging may be applied:

Param_filtered(n)=Param(n)*alpha+Param_filtered(n−1)*(1−alpha)

where alpha is a value taken from the interval [0,1]. The value of alpha used for a given estimated parameter should be selected as inversely proportional to the amount of noise for that parameter. For example, in the case of ToF image sensors, the alpha value for filtering Z coordinates should be less than the alpha values for filtering respective X and Y coordinates, as there is generally more noise in the Z coordinate than in the X and Y coordinates for such sensors. Smoothing of the type described above may be applied regardless of the particular estimation technique used to determine the X, Y and Z coordinates.

Block γ of the dynamic gesture recognizer 115B stores timestamps, evaluated features, hand pose information and NLLs in the history buffer 302 for use by other processing blocks of the recognizer.

Blocks δ₁ through δ₆ implement respective detectors for the six distinct gestures of the gesture vocabulary. These detectors are configured to reduce both the computational complexity and the false positive rate of the GR system 110. The implementation of a given one of the detectors depends on the particular gesture being recognized. Examples of detectors for the swipe right, swipe left, swipe up, swipe down, poke and wave gestures are as follows:

1. Swipe left detected=dx<−dxₘᵢₙ && Vx<−max(|Vy|, |Vz|) where for example dxₘᵢₙ=0.2 m.

2. Swipe right detected=dx>dxₘᵢₙ && Vx>max(|Vy|, |Vz|).

3. Swipe up detected=dy>dyₘᵢₙ && Vy>max(|Vx|, |Vz|), where for example dyₘᵢₙ=0.2 m and it is assumed that the image sensor is oriented to the user and the y axis is oriented upwards.

4. Swipe down detected=dy<−dyₘᵢₙ && Vy<−max(|Vx|, |Vz|)

5. Poke detected=dz<−dzₘᵢₙ && Vz<−max(|Vx|, |Vy|) where for example dzₘᵢₙ=0.05 m and it is assumed that both the image sensor and the z axis are oriented towards the user.

6. Wave detected=number of zero crossings in the history buffer for Vx is greater than or equal to 3 && max(|Vxₘₐₓ|, |Vxₘᵢₙ|)>max(|Vyₘₐₓ|, |Vyₘᵢₙ|, |Vzₘₐₓ|, |Vzₘᵢₙ|), where a zero crossing is defined as Vx(n)>0 && Vx(n−1)<=0∥Vx(n)<0 && Vx(n−1)>=0.

Each of Blocks δ₁ through δ₆ is configured to generate as its detection output for the current frame either a logic 1 indicating that the corresponding gesture is detected or a logic 0 indicating that the corresponding gesture is not detected. These outputs are also referred to herein as respective affirmative and negative detection outputs. Decision blocks associated with respective ones of Blocks δ₁ through δ₆ process the detection outputs to control selective enabling of subsequent estimator blocks. Thus, for each of the gesture detectors that generates an affirmative detection output, the corresponding estimator is enabled. For any gesture detectors that generate a negative detection output, the corresponding estimator is effectively disabled by bypassing it and arbitrarily assigning a large similarity measure in Block ε. In other embodiments, the decision blocks associated with respective Blocks δ₁ through δ₆ may be incorporated within those latter blocks, rather than implemented as separate elements.

Blocks η₁ through η₆ implement respective estimators for the six distinct gestures of the gesture vocabulary. These estimators are utilized in generating the above-described similarity measures dᵢ for the respective swipe right, swipe left, swipe up, swipe down, poke and wave gestures. In some embodiments, such as the embodiment of FIG. 3 in which the dynamic gesture recognizer 115B includes an additional estimator implemented by Block θ, the similarity measures generated by the individual gesture estimators in Blocks η₁ through η₆ are referred to as “preliminary similarity measures.” However, in other embodiments the additional estimator can be eliminated and the similarity measures provided by the individual gesture estimators can serve as the output similarity measures of the dynamic gesture recognizer without further processing in an additional estimator.

As mentioned previously, the similarity measures may correspond to respective NLLs. More particularly, a given estimator can be implemented as a statistical classifier that is trained using sample gestures and a set of dynamic hand features and returns an NLL. For example, the statistical classifier may be configured using GMMs and trained with a minimal set of dynamic features such as the set of velocity coordinates {Vx, Vy, Vz}, although it is to be appreciated that other dynamic features may be used in the statistical classifier in order to further improve gesture recognition performance.

Block θ implements what is referred to herein as a “turbo” gesture estimator. This estimator combines NLLs and hand pose information for the current frame with NLLs and hand pose information for one or more previous frames. This further reduces the rate of false positives as well as other gesture recognition errors. The turbo gesture estimator is an example of what is more generally referred to herein as an “additional estimator” relative to the individual gesture estimators of Blocks η₁ through η₆.

Let P₁(n−1), P₂(n−1), . . . P_{N}(n−1) be a posteriori probabilities or probability densities returned by respective gesture estimators η₁ through η₆ for the previous frame n−1 and p₁(n), p₂(n), . . . p_{N}(n) be current probabilities or probability densities returned by the respective gesture estimators η₁ through η₆ for frame n. The turbo gesture estimator implemented by Block θ is illustratively configured to perform the following operation:

Pᵢ(n)=Pᵢ(n−1)*pᵢ(n)/pₛᵤₘ(n),

where pₛᵤₘ(n)=sum(pᵢ(n), i=1 . . . N) is a normalization coefficient since pₛᵤₘ(n) may not equal 1 if probability densities rather than probabilities are used. The same formula in logarithmic form is as follows:

NLLᵢ(n)=NLLᵢ(n−1)−log(pᵢ(n))+log pₛᵤₘ(n).

Defining Nₘₐₓ as history length results in the following formula for NLLᵢ(n):

NLLᵢ(n)=NLLᵢ(n−2)−(log(pᵢ(n−1))+log(pᵢ(n)))+log pₛᵤₘ(n)+log pₛᵤₘ(n−1)= . . . =−sum(log(pᵢ(k), k=n−Nmax+1, . . . , n)+sum(log pₛᵤₘ(k), k=n−Nmax+1, . . . , n)(*)

The NLLᵢ(n) values in this embodiment correspond to the respective similarity measures dᵢ for frame n at the output of the turbo gesture estimator. As mentioned previously in conjunction with FIG. 2, these or other types of similarity measures are applied to the minimum determining element 208 and the resulting minimum valued similarity measure is further subject to the postprocessing detector in decision block 210. In an embodiment in which the postprocessing detector is not used, formula (*) may be simplified by removing the last term sum(log pₛᵤₘ(k), k=n−Nmax+1, . . . , n) which does not depend on gesture index i and thus does not change the index of a most probable gesture. The simplified formula for dᵢ(n) accumulates gesture estimator NLLs over time:

NLLᵢ(n)=−sum(log(pᵢ(k), k=n−Nmax+1, . . . , n), i=1 . . . N(**)

In order to facilitate rejection of out-of-vocabulary gestures, the probability densities at the output of the gesture estimators can be normalized as follows:

NLLᵢ(n)=−sum(log(pᵢ(k)/pₛᵤₘ(k)), k=n−Nmax+1, . . . , n), i=1 . . . N.

This normalization ensures that the output of the minimum determining element 208 is suitable for comparison with the threshold D_{threshold} in the postprocessing detector 210.

As indicated above, the turbo gesture estimator not only utilizes gesture estimator NLLs accumulated over time using history buffer 302, it also utilizes accumulated hand pose NLLs calculated in Block α of the module. The hand pose NLLs are accumulated for gesture classes G¹, G², . . . , G^{K}, rather than for individual gestures, which makes implementation even more efficient. Similar to formula (*) above for the gesture estimator NLLs, the following formula applies to the hand pose NLLs:

πNLLⱼ(n)=−sum(log(πᵢ(k)/πₛᵤₘ(k)), k=n−Nmax+1, . . . , n), j=1 . . . K(***)

where πNLLⱼ(n) denotes hand pose NLLs for classes G¹, G², . . . , G^{K}, πᵢ(k) denotes raw hand pose classifier output for frame n and πₛᵤₘ(k) is a normalization coefficient.

In this embodiment, similarity measures dᵢ, i=1 . . . N for frame n are calculated using both the gesture estimator NLLs and the hand pose NLLs according to the following formula:

dᵢ=w*NLLᵢ(n)+(1−w)*πNLLⱼ(n),

where w is a coefficient from the interval [0,1] which indicates the relative importance of dynamic and static hand characteristics as reflected in the respective gesture estimator NLLs and static hand pose NLLs. For example, w=0.5 may be used in a simple case. However, in order to achieve better performance, w should be set to a value greater than 0.5, as dynamic characteristics of a hand are more important than static characteristics in the recognition of dynamic gestures such as those used in the present embodiment.

As indicated above, Block ε assigns arbitrary large numbers to similarity measures corresponding to those gestures which did not result in an affirmative output from the corresponding gesture detectors of respective Blocks δ₁ through δ₆. This ensures that these gestures will not be identified by the recognizer 115B.

The particular types and arrangements of processing blocks shown in the embodiments of FIGS. 2 and 3 are exemplary only, and additional or alternative blocks can be used in other embodiments. For example, blocks illustratively shown as being executed serially in the figures can be performed at least in part in parallel with one or more other blocks or in other pipelined configurations in other embodiments.

The illustrative embodiments provide significantly improved gesture recognition performance relative to conventional arrangements. For example, these embodiments are not only able to detect hand gestures in which the hand is moving rapidly, but can also detect hand gestures in which the hand is moving slowly or not moving at all. Accordingly, a wide array of different hand gestures can be efficiently and accurately recognized. Also, the rate of false positives and other gesture recognition error rates are substantially reduced.

Different portions of the GR system 110 can be implemented in software, hardware, firmware or various combinations thereof. For example, software utilizing hardware accelerators may be used for some processing blocks while other blocks are implemented using combinations of hardware and firmware.

At least portions of the GR-based output 112 of GR system 110 may be further processed in the image processor 102, or supplied to another processing device 106 or image destination, as mentioned previously.

It should again be emphasized that the embodiments of the invention as described herein are intended to be illustrative only. For example, other embodiments of the invention can be implemented utilizing a wide variety of different types and arrangements of image processing circuitry, modules, processing blocks and associated operations than those utilized in the particular embodiments described herein. In addition, the particular assumptions made herein in the context of describing certain embodiments need not apply in other embodiments. These and numerous other alternative embodiments within the scope of the following claims will be readily apparent to those skilled in the art.

What is claimed is:

1. A method comprising:
determining velocity of a hand in a plurality of images; and
selectively enabling dynamic gesture recognition for at least one image responsive to the determined velocity;
wherein the determining and selectively enabling are implemented in an image processor comprising a processor coupled to a memory.

2. The method of claim 1 wherein determining velocity comprises determining an average velocity of the hand utilizing a current frame and at least one previous frame.

3. The method of claim 1 wherein selectively enabling dynamic gesture recognition for at least one image comprises selectively enabling dynamic gesture recognition for the current frame.

4. The method of claim 1 wherein selectively enabling dynamic gesture recognition for at least one image comprises:
comparing the determined velocity for a current frame to a specified velocity threshold;
if the determined velocity is greater than or equal to the velocity threshold, executing the dynamic gesture recognition for the current frame; and
if the determined velocity is less than the velocity threshold, bypassing the dynamic gesture recognition for the current frame.

5. The method of claim 1 wherein the dynamic gesture recognition comprises generating similarity measures for respective ones of a plurality of gestures of a gesture vocabulary for a current frame.

6. The method of claim 5 wherein the similarity measures comprise respective negative log likelihoods.

7. The method of claim 5 wherein the dynamic gesture recognition further comprises:
selecting a particular one of the similarity measures based on one or more specified criteria; and
controlling generation of a gesture recognition event based on comparison of the selected similarity measure to a specified distance threshold.

8. The method of claim 5 further comprising:
grouping the gestures of the gesture vocabulary into classes comprising respective non-intersecting and non-empty subsets of the gestures based on hand shape; and
training classifiers for the respective classes.

9. The method of claim 8 wherein the dynamic gesture recognition further comprises:
generating static hand pose similarity measures for the current frame using the respective classifiers;
evaluating dynamic hand parameters for the current frame; and
utilizing the static hand pose similarity measures in conjunction with the dynamic hand parameters to generate the similarity measures for the respective gestures for the current frame.

10. The method of claim 9 wherein utilizing the static hand pose similarity measures in conjunction with the dynamic hand parameters comprises:
applying the static hand pose similarity measures and the dynamic hand parameters to gesture detectors configured to detect respective gestures of the gesture vocabulary;
for those gesture detectors that generate an affirmative detection output, enabling a corresponding gesture estimator to generate a preliminary similarity measure for the corresponding gesture; and
processing multiple preliminary similarity measures for respective ones of the gesture estimators utilizing historical information comprising static hand pose similarity measures and preliminary similarity measures from one or more previous frames in order to generate the similarity measures for the respective gestures for the current frame.

11. A non-transitory computer-readable storage medium having computer program code embodied therein, wherein the computer program code when executed in the image processor causes the image processor to perform the method of claim 1.

12. An apparatus comprising:
an image processor comprising image processing circuitry and an associated memory;
wherein the image processor is configured to determine velocity of a hand in a plurality of images, and to selectively enable dynamic gesture recognition for at least one image responsive to the determined velocity.

13. The apparatus of claim 12 wherein the image processor comprises:
a dynamic gesture preprocessing detector; and
a dynamic gesture recognizer;
wherein the dynamic gesture preprocessing detector is configured to determine the velocity of the hand for a current frame and to compare the determined velocity to a specified velocity threshold;
wherein if the determined velocity is greater than or equal to the velocity threshold, the dynamic gesture recognizer operates on the current frame; and
if the determined velocity is less than the velocity threshold, the dynamic gesture recognizer is bypassed for the current frame.

14. The apparatus of claim 13 wherein the dynamic gesture recognizer is configured to generate similarity measures for respective ones of a plurality of gestures of a gesture vocabulary for a current frame.

15. The apparatus of claim 14 wherein the image processor further comprises:
a selection element configured to select a particular one of the similarity measures based on one or more specified criteria; and
a dynamic gesture postprocessing detector configured to control generation of a gesture recognition event based on comparison of an output of the selection element to a specified distance threshold.

16. The apparatus of claim 14 wherein the dynamic gesture recognizer comprises a static hand pose estimator implementing a plurality of classifiers trained for respective classes comprising respective non-intersecting and non-empty subsets of the gestures, with the gestures being grouped into the classes based on hand shape.

17. The apparatus of claim 16 wherein the dynamic gesture recognizer further comprises:
a dynamic hand parameter evaluator; and
a plurality of gesture detectors configured to detect respective gestures of the gesture vocabulary;
the gesture detectors being configured to receive static hand pose similarity measures for the current frame from the respective classifiers of the static hand pose estimator;
the gesture detectors being further configured to receive dynamic hand parameters for the current frame from the dynamic hand parameter evaluator;
wherein the gesture detectors generate respective outputs indicating whether or not the corresponding gesture is detected in the current frame.

18. The apparatus of claim 17 wherein the dynamic gesture recognizer further comprises:
a plurality of gesture estimators for respective ones of the gestures;
each of said gesture estimators having an input coupled to an output of a corresponding one of the gesture detectors;
wherein the gesture estimators are selectively enabled responsive to affirmative outputs from respective ones of the gesture detectors.

19. The apparatus of claim 18 wherein the dynamic gesture recognizer further comprises an additional estimator having inputs coupled to outputs of respective ones of the gesture estimators, the additional estimator being configured to processing multiple preliminary similarity measures for respective enabled ones of the gesture estimators utilizing historical information comprising static hand pose similarity measures and preliminary similarity measures from one or more previous frames in order to generate the similarity measures for the respective gestures for the current frame.

20. An integrated circuit comprising the apparatus of claim 12.

21. An image processing system comprising the apparatus of claim 12.
